(19) United States
(12) Patent Application Publication
(10) Pub. No.: US 2025/0067303 A1
(43) Pub. Date: Feb. 27, 2025

(54) MULTIDIRECTIONAL HYDRAULIC DAMPING BEARING

(71) Applicant: VORWERK AUTOTEC GMBH & CO. KG, Wuppertal (DE)

(72) Inventors: Kevin BOSBACH, Kierspe (DE); Andreas KRAJEWSKI, Schwelm (DE)

(21) Appl. No.: 18/809,449

(22) Filed: Aug. 20, 2024

(30) Foreign Application Priority Data
Aug. 21, 2023 (DE) 10 2023 122 308.9

(51) Int. Cl. F16C 27/02

(52) U.S. Cl. CPC F16C 27/02

(57) ABSTRACT

A hydraulic damping bearing comprising an axially extending inner element, an elastomer body, a cage element that is embedded at least in sections in the elastomer body, wherein the elastomer body elastically connects the cage element and the inner element with one another, an outer sleeve that wraps around the inner element, the cage element and the elastomer body, at least a first, a second, a third and a fourth fluid chamber arranged respectively between the outer sleeve and the inner element that are connected by fluid channels. Each of the at least flour fluid chambers is designed and set up in such a manner that, in case of a relative displacement of the inner element and of the cage element in a first direction and of a relative displacement of the inner element and of the cage element in a second direction, it is involved in performing damping tasks.

### FIELD

This invention relates to a hydraulic damping bearing comprising an axially extending inner element, an elastomer body as well as a cage element that is embedded at least in sections in the elastomer body, wherein the elastomer body elastically connects the cage element and the inner element with one another as well as an outer sleeve that wraps around the inner element, the cage element and the elastomer body, wherein at least a first and a second fluid chamber arranged respectively between the outer sleeve and the inner element and connected by a fluid channel are provided.

### BACKGROUND

Such bearings are used, for example, as bush bearings for bearing the handlebar of a vehicle suspension or for bearing aggregates, in particular for the engine mount of motor vehicles. In order to provide improved damping in particular in operating such motor vehicles in predefined excitation frequency ranges or amplitude ranges compared with that achieved with a mere elastomer damping, such a generic bearing is designed for performing hydraulic damping tasks in response to corresponding mechanical stimulations. To this end, the at least two fluid chambers fluidly connected by means of a fluid channel are designed in such a manner that, in case of a mechanical deflection of the cage element with respect to the inner element, the volume of a fluid chamber can be reduced while the volume of another fluid chamber associated to the first-mentioned chamber may increase so that a fluid exchange can take place between the chambers. The fluid can preferably be designed as a damping fluid. The fluid flows via the at least one fluid channel between the fluid chambers connected with one another so that hydraulic damping tasks are performed. This being, the at least two fluid chambers connected by a damping channel are limited in sections by at least one swelling spring portion and/or at least one support spring portion. A mechanical stress of the bearing also known as a hydraulic bearing results in that damping fluid escapes via the at least one damping channel from one chamber to the other chamber and/or an associated swelling spring portion expands. Such a generic hydraulic bearing is disclosed, for example, in the German patent application DE 10 2019 007 526 A1.

Depending on the application, it can be appropriate to design a hydraulic bearing not only with respect to a single working or main damping direction in which a hydraulic damping is provided in response to mechanical excitations of predefined excitation frequencies or amplitude ranges, but also in several, for example two excitation directions that can be arranged in particular perpendicularly to one another. To this end, the application DE 10 2007 016 399 A1 describes a multidirectional hydraulic damping bearing that is set up and designed to perform damping tasks in an axial direction of the bearing as well as in a radial direction of the bearing. To this end, the known hydraulic bearing has a housing with a housing upper part and a housing lower part connected with the housing upper part as well as an elastomer damping arrangement accommodated by the housing and acting axially as well as radially. This damping arrangement comprises at least one pair of chambers extending over the whole circumference, arranged in the axial direction to one another as well as at least one pair of chambers arranged in the radial direction to one another and connected by at least one channel for a hydraulic damping means. This being, the housing upper part forms a carrying body that has an inner core, an outer wall of the housing upper part radially spaced from the inner core and an elastomer spring connected by vulcanization with the inner core and the outer wall that is supported in the axial direction against the outer wall. However, the construction of this multidirectional hydraulic damping bearing is very complex and requires a multitude of components so that there is a need for proving a hydraulic bearing that is able to perform hydraulic damping tasks in several working directions that can be oriented in particular perpendicularly to one another and that simultaneously has a simple structure so that it can be produced cost-effectively.

### SUMMARY

The bearing according to the invention has an axially extending inner element, an elastomer body, a cage element that is embedded at least in sections in the elastomer body, wherein the elastomer body elastically connects the cage element and the inner element with one another, an outer sleeve that wraps around or radially encompasses the inner element, the cage element and the elastomer body, as well as at least a first and a second fluid chamber arranged respectively between the outer sleeve and the inner element and connected by a fluid channel. The bearing according to the invention is wherein it comprises, besides the first and the second fluid chamber, at least a third and a fourth fluid chamber that are arranged respectively between the outer sleeve and the inner element, wherein the at least four fluid chambers are fluidly connected via at least one further fluid channel and wherein each of the at least four fluid chambers is involved, in case of a relative displacement of the inner element and of the cage element in a first main direction and of a relative displacement of the inner element and of the cage element in a second main direction, in performing damping tasks, i.e. each of the at least four fluid chambers is part of a hydraulic system in which a hydraulic damping task can be performed as well in case of a relative displacement of the inner element and of the cage element in a first main direction as in case of a relative displacement of the inner element and of the cage element in a second main direction. Both main directions can preferably be oriented perpendicularly to one another, in particular an axial direction and a radial direction.

This invention is based on the basic idea to design a multidirectional hydraulic damping bearing on the basis of an uniaxially damping hydraulic bearing known per se that comprises a cage element embedded in the elastomer body, wherein according to the invention at least four fluid chambers are provided that are connected by fluid channels and the at least four fluid chambers are involved in performing hydraulic damping tasks respectively independently of the fact if the hydraulic bearing is loaded in a first or a second direction, or main direction. This being, this involvement in performing damping tasks can in particular consist in that damping fluid, in particular a damping liquid, flows out of or into a fluid chamber via an associated fluid channel, wherein a hydraulic damping task can basically be performed in the fluid channel that connects a fluid dispensing fluid chamber and a fluid receiving fluid chamber.

The hydraulic damping bearing according to the invention is characterized with the described structure in that a multidirectional damping bearing is provided that comprises comparatively few components, that makes possible a compact design and that further makes possible the setting up of different damping properties of the bearing in two main loading directions. According to the invention, the at least four fluid chambers are designed together with the fluid channels for respectively providing a hydraulic damping system acting and performing damping tasks in the second direction. This being, both main directions can be preferably situated perpendicularly to one another, in particular the first main direction can constitute an axial direction of the bearing and the second main direction a radial direction of the bearing. In this embodiment, the at least four fluid chambers can respectively be designed and set up so that they act as fluid chambers of a damping system in case of a bearing stress in the radial direction as well as in case of a bearing stress in the axial direction, these chambers cooperating with one associated of the other fluid chambers and with a fluid channel fluidly connecting the two associated fluid chambers for performing damping tasks.

Further characteristics according to the invention and further developments of the invention are stated in the following general description, in the figures, the description of the figures as well as in the subclaims.

To provide a hydraulic bearing working in two directions, in particular in two main directions, it can be provided that the bearing according to the invention comprises at least two pairs of fluid chambers axially superimposed and arranged at least overlapping in the circumferential direction, wherein the at least two pairs are circumferentially spaced from each other. The circumferential spacing of the two pairs of axially superimposed fluid chambers can preferably be between 90° and 180°, wherein in particular the two threshold values of the circumferential spacing, i.e. 90° or 180°, are possible. It can be particularly appropriately provided that the two pairs of axially superimposed fluid chambers are arranged radially opposite, i.e. diametrically opposite one another, corresponding to a circumferential spacing of approximately 180°.

Depending on the embodiment, the two pairs of axially superimposed fluid chambers can be arranged at a different axial height inside the bearing. It can be particularly appropriately provided that the two pairs of axially superimposed fluid chambers are situated at the same axial height. The latter may result in that a radial portion, in particular a radial wall portion of the bearing that separates or divides a pair of axially superimposed fluid chambers, is situated at the same height than a radial portion of the bearing that divides or separates the other of the two pairs of axially superimposed fluid chambers.

The multidirectional hydraulic damping bearing according to the invention can be designed in particular as a bush bearing to be arranged in an associated bearing eye of a first component, for example of a motor vehicle component, wherein the outer circumferential surface of the outer sleeve of the bearing is designed to rest against a boundary surface of the first component that defines the bearing eye and is adapted to the circumferential surface of the outer sleeve, and the inner element is designed to be fixed to a second component, in particular to a second component of the motor vehicle. This being, it can be provided that the inner element of the bearing according to the invention has a duct extending in the axial direction for receiving a fastening bolt for fixing the bearing according to the invention to said second component of the motor vehicle.

To provide a symmetric response of the multidirectional hydraulic damping bearing according to the invention, it can be appropriately provided that the two fluid chambers of each pair of axially superimposed fluid chambers substantially extend over the same circumferential portion.

It can be preferably provided that the at least four fluid chambers have substantially the same extension, i.e. an identical extent in the circumferential direction of the bearing. It can be provided in particular that respectively two fluid chambers are arranged on the same circumferential portion and axially offset and form a first and a second pair of fluid chambers, wherein the two pairs of the respectively two fluid chambers are arranged circumferentially offset by approximately 180°.

For minimizing the design efforts, it can be provided that each of the at least four fluid chambers is fluidly connected with a single one of the other three fluid chambers via a fluid channel, wherein the fluid chambers connected with one another are arranged radially opposite and axially consecutive, i.e. above one another. For this embodiment, each fluid chamber can have a single associated fluid chamber for exchanging damping fluid and thus a single damping channel between associated fluid chambers so that the damping is adjusted, for example, for a radial stress as well as for an axial stress with a substantially same hydraulic damping system since the respective damping channel or fluid channel is identical for both main stress directions.

It can preferably be provided that each fluid channel fluidly connects exactly two fluid chambers comprised by the bearing according to the invention.

For the separate adjustment of the hydraulic damping of the bearing according to the invention in different directions, it can appropriately be provided that four fluid channels are respectively arranged between the at least four fluid chambers. This being, it can be provided that two fluid channels are arranged between the at least four fluid chambers for performing damping tasks in a first main direction, for example in the axial direction, and two fluid channels are arranged for performing damping tasks in a second main direction, for example in the radial direction.

Preferably, the fluid channels have a geometrically different design for providing a damping in the first main direction (for example in the radial direction) and fluid channels for providing a damping in the second main direction (for example in the axial direction), in particular with respect to diameter, length and/or curvature of the respective fluid channel. Insofar, the design of the hydraulic bearing according to the invention can be constructed in such a manner that, when a stress occurs on the bearing in one of the two main directions, two hydraulic systems that comprise associated fluid chambers that are connected by an associated fluid channel always work, i.e. that they perform damping tasks.

It can be provided that each of the at least four fluid chambers is fluidly connected by means of a fluid channel with a first axially spaced associated fluid chamber, and simultaneously the first mentioned fluid chamber is connected with a second circumferentially spaced fluid chamber by another fluid channel. The hydraulic bearing according to the invention can thus advantageously provide two hydraulic systems for simultaneously performing damping tasks for any mechanical stress that results to a relative displacement of the inner element and of the cage element of the bearing. These two hydraulic systems can be provided regardless of whether the mechanical stress of the hydraulic bearing in a single of the two main directions that are perpendicularly to one another and that can be, for example, an axial direction and a radial direction, or causes a loading component of the bearing into the first main direction as well as a loading component of the bearing into the second main direction, wherein both damping systems are set up for performing damping tasks involving all the four fluid chambers and involving the fluid channels that connect these chambers.

For separating two fluid chambers arranged in the area of the same circumferential portion and axially spaced or consecutive and above referred to as a pair, it can be appropriately provided that the cage element comprises in the longitudinal section of the bearing a first transverse web that can also be referred to as a radial web, that extends radially in direction of the inner element, wherein this transverse web can be designed for providing a respective axial pump surface for the two fluid chambers arranged over a predefined circumferential section and axially consecutive. Preferably, this first radial or transverse web can engage on radially or diametrically opposite longitudinal webs of the cage element or start therefrom. It should be noted that such a transverse or radial web can be coated with elastomer material for defining a respective boundary surface of the two axially adjacent or consecutive fluid chambers that can constitute a pair of axially adjacent fluid chambers.

For providing a further pair of axially consecutive or adjacent fluid chambers, it can be appropriately provided that a second transverse web or radial web of the cage element is provided additionally to said first transverse web or radial web, preferably radially opposite thereto, in the longitudinal section of the bearing, this second transverse web extending like the first transverse web radially in direction of the inner element, again for providing a respective axial pump surface of the two other fluid chambers arranged over a predefined circumferential portion and axially consecutive, i.e. of a second pair of axially consecutive fluid chambers. It can preferably be provided that the two transverse webs or radial webs are arranged approximately at the same axial height of the bearing. Furthermore, it can be provided that the second transverse web or radial web also extends to the diametrically opposite longitudinal webs of the cage element to which the second transverse web or radial web is also fixed on the cage element.

It can appropriately be provided that one of the two transverse webs, in particular both transverse webs, has a fork-shaped split-up in the area of its transition to a respective longitudinal web of the cage element with two axially spaced and axially contrary extensions that merge into the associated longitudinal web of the cage element or that can be integrally formed therewith. For designing a low radial rigidity of the hydraulic bearing according to the invention in a predefined circumferential region, it can appropriately be provided that the respective transverse web or radial web extends between the extensions or fixings on the longitudinal webs of the cage element by being spaced from the inner element. This being, it can be provided that two inner elastomer chamber wall portions that are contrary and bent, adherent to the radial end portion of the respective transverse web that is facing the inner element, extend adherent to the inner element for the axial delimitation of the two axially consecutive fluid chambers. This being, it can be preferably provided that the two elastomer chamber wall portions are axially spaced from one another, wherein, for defining a particularly low radial rigidity of the bearing, a hollow space formed between the two chamber wall portions and the inner element is filled with a gaseous medium, in particular with air, for providing a free space for the elastically deformable elastomer chamber wall portions.

Appropriately, the cage element of the hydraulic bearing configured according to the invention can comprise at least two axially spaced ring portions that are connected by at least two in particular diametrically opposite longitudinal webs, wherein the first and/or the second transverse web can be connected as described above respectively with its longitudinal end(s) to the two longitudinal webs of the cage element, can in particular be integrally formed therewith. Depending on the embodiment, the cage element can be designed in one or several parts.

It can appropriately be provided that the cage element is designed in two parts, wherein mutually associated bearing faces can extend through the diametrically opposite or circumferentially spaced longitudinal webs. Preferably, it can be provided that the two parts of such a cage element comprise complementarily acting connecting elements in the area of their bearing faces, in particular such connecting elements that can engage in the axial direction and that provide form-fitting portions acting in the radial direction.

Appropriately, the elastomer body can comprise support spring portions, arranged radially between the longitudinal webs of the cage element and the inner element of the hydraulic bearing configured according to the invention, that enable a high radial stiffness of the bearing due to the diametral arrangement of the two longitudinal webs of the cage element in a predefined radial direction of the bearing. Conversely, the elastomer body can comprise two hollow spaces extending transversely to the longitudinal direction of the inner element, in particular linearly and parallel to one another and limited by elastomer wall portions, for example hollow spaces filled with air, that are respectively adjacent to the inner element so that a comparatively low radial stiffness compared to that of the support spring portion can be provided circumferentially offset in a radial direction, in particular circumferentially offset by 90 degrees, to the diametrically opposite longitudinal webs of the cage element. This being, it can be provided that these elastomer wall portions are identical with the above-described inner elastomer chamber wall portions that start from the radial end portion facing the inner element of the respective transverse web and that are axially contrary and bent.

In particular to provide radially acting pump surfaces of the at least four fluid chambers and to provide the fluid channels, the multidirectional hydraulic damping bearing according to the invention can comprise a, for example, two-part channel shell that is arranged axially between the ring portions of the cage element and that terminates the fluid chambers to the outer sleeve and that can also comprise radial grooves for providing at least two, in particular at least four, fluid channels that can be at least partially formed by the radial grooves of the channel shell and associated inner wall portions of the outer sleeve.

Depending on the number of the fluid channels starting from a fluid chamber, the mentioned radial recesses can have a different design. For such embodiments for which only two fluid channels are formed between the at least four fluid chambers, in case of a two-part channel shell, the two channel half shells comprise respectively radial grooves for the respective partial configuration of the two fluid channels. In such an embodiment for which four fluid channels are provided for the fluidic connection of the four fluid chambers, one of the two respective channel half shells can comprise a complete fluid channel or a radial groove associated to a complete fluid channel for providing a fluid connection between a pair of axially adjacent or spaced fluid chambers and moreover two radial groove portions, in particular axially spaced and circumferentially extending groove portions that, when the two channel half shells are assembled, correspond to two radial grooves of the other channel half shell and merge into one another for providing two fluid channels for constituting a fluid connection between respectively two circumferentially spaced fluid chambers. For respectively providing a fluid connection between a respective radial groove and the two associated fluid chambers, the radial grooves can comprise a radial opening or passage through the respective half shell respectively at its longitudinal ends or respectively at one of its longitudinal ends.

For increasing the stability of the hydraulic bearing according to the invention against outer operating forces, it can appropriately be provided that the channel shell has a radial passage as a receptacle in which, the bearing being in the assembled state, a radially extending portion of a transverse web of the cage element extends that, as described above, separates the two axially spaced fluid chambers of a pair of fluid chambers.

It can appropriately be provided that the inner element of the hydraulic bearing according to the invention comprises an approximately square cross-section in an axial portion over which the fluid chambers extend. This design of the inner element makes possible, on the one hand, a simple design of support spring portions on opposite sides of the approximately square cross-section of the inner element and, simultaneously on the two other sides of the square cross-section, to provide elastomer chamber wall portions extending from the respective radial end portion of a transverse web facing the inner element to the inner element for separating the axially adjacent fluid chambers and for providing the described low radial stiffness of the bearing in a direction approximately perpendicular to the latter two sides faces of the square cross-section within the axial extension of the fluid chambers of the bearing. Said comparatively high radial stiffness of the bearing can thus be made possible approximately perpendicularly to the diametrically opposite side faces of the inner element on which support spring portions of the elastomer body are arranged.

For providing an attachment on the inner part side of a respective outer elastomer chamber membrane wall and for increasing axially acting pump faces, it can appropriately be provided that the inner element comprises a collar-like flange. This being, it can preferably be provided that the inner element comprises such a collar-like flange on both axial end portions of the fluid chambers of a pair of fluid chambers. Depending on the embodiment, this flange can have a circumferential design. However, it is also possible, in particular for an embodiment for which the inner element has an approximately square cross-section in the axial portion of the fluid chambers, that this collar-like flange has a square design.

The inner element can, for example, be made of a plastic material or of a metallic material. However, it is also possible that the inner element comprises a metal core with a plastic sheath attached thereto, in particular an injection molded shell, that defines at least in sections the circumferential design of the inner element.

The outer sleeve can, for example, be made of a plastic material or of a metallic material, for example of aluminum or steel. The same applies to the cage element and the channel shell; preferably, they can be made of a plastic material, in particular of a fiber-reinforced plastic material.

In order to protect the multidirectional hydraulic damping bearing according to the invention against unwanted force effects onto elastomer chamber wall portions of the fluid chambers in case of increased radial operating forces, it can appropriately be provided that an annular abutment element is provided on an axial end portion of the bearing axially outside the fluid chambers on the inner element, this element being arranged radially spaced in the load-free state of the bearing from an elastomer portion arranged on an inner face of a ring element of the cage element. This being, it can be provided that radial circumferential portions of the abutment element, in case of an increased mechanical radial stress of the bearing, come to rest on associated elastomer portions of the ring element of the cage so that a further relative movement of the inner element to the cage element or to the outer sleeve of the bearing is prevented. Insofar, a radial limitation of the displacement of the inner element and of the cage element can be provided. It can appropriately be provided that the elastomer portion of the ring element cooperating with the abutment element is designed as an axial extension of an outer chamber membrane wall. In an embodiment, it can also be provided that the annular abutment element is integrally formed with the inner element.

It can be preferably provided that the multidirectional hydraulic damping bearing according to the invention is also protected against an excessive displacement of the inner element and of the cage element or of the outer sleeve in the axial direction. To this end, it can be provided that an axial front face of the cage is coated with an elastomer buffer that is situated axially below a front side end face of the inner element so that, in case the front side end face of the inner element rests in an assembled state of the bearing on an abutment surface of another component that extends radially beyond the inner element, in the event of a relative displacement of the inner element and of the cage element or of the outer sleeve to one another, this displacement is limited to the overhang of the front side end face of the inner element with respect to the associated end face of the elastomer buffer on the axial front face of the cage.

### BRIEF DESCRIPTION OF THE DRAWINGS

The invention will be explained below by describing an embodiment of the multidirectional hydraulic damping bearing according to the invention besides variations with reference to the attached drawings.

FIG. 1 shows a perspective half-section representation of a multidirectional hydraulic damping bearing according to the invention with two section planes perpendicular to one another.

FIG. 2 shows a perspective view of the inner element of the hydraulic bearing according to the invention of FIG. 1.

FIG. 3 shows a perspective view of the cage element of the hydraulic bearing according to the invention of FIG. 1.

FIG. 4 shows one of the two channel half shells of the hydraulic bearing according to the invention of FIG. 1.

FIG. 5 shows the hydraulic bearing shown in FIG. 1 in a (partial) exploded view.

FIG. 6 shows the hydraulic bearing shown in FIG. 1 in a first full section representation.

FIG. 7 shows the hydraulic bearing shown in FIG. 1 in a second full section representation.

### DETAILED DESCRIPTION

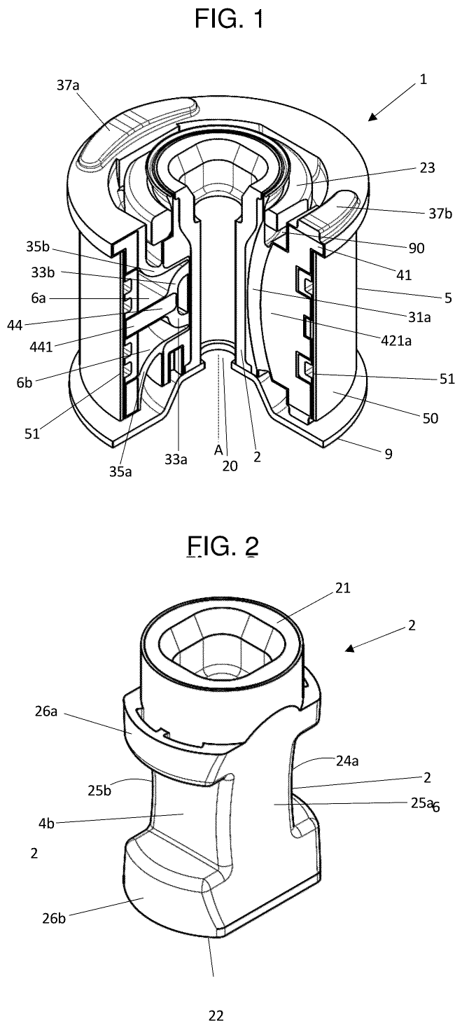

The invention shall be explained below and illustrated by an example of a multidirectional hydraulic damping bearing as it can be used, for example, for bearing aggregates in the automotive sector, in particular for the engine mount inside the bodywork of a motor vehicle. FIG. 1 shows a perspective half-section representation of the multidirectional hydraulic damping bearing according to the invention with two section planes that are both oriented parallel to the bearing axis A and perpendicular to one another. The hydraulic bearing 1 is designed as a bush bearing with an inner element 2 that can comprise in the described embodiment a bore 20 for receiving a fastening bolt for fixing to a first component of a motor vehicle. The hydraulic bearing 1 is closed over a significant portion of its axial extension radially by an outer sleeve 5 that, when mounted, is applied with its outer circumferential surface 50 that can generally be designed cylindrical to a boundary surface of a bearing eye receiving the hydraulic bearing 1, for example by press-fitting. These boundary surfaces can be designed as a part of a second component of a motor vehicle so that the hydraulic bearing 1 according to the invention can be designed for bearing both components of a motor vehicle.

The bearing comprises an elastomer body arranged between the inner element 2 and the outer sleeve 5 that can have, in the described embodiment, two diametrically opposite support spring portions 31a, 31b of which only the support spring portion 31a that substantially extends over the whole axial extension of the bearing is visible because of the described representation. Both support spring portions 31a, 31b can be identically designed.

Two axially consecutive or axially adjacent fluid chamber pairs 6a, 6b; 7a, 7b can in turn be arranged respectively diametrically opposite and circumferentially offset approximately by 90° to the diametrical arrangement of the support spring portions 31a, 31b of which again, because of the described representation of FIG. 1, only the fluid chambers 6a, 6b are visible as a chamber pair. For designing these fluid chambers 6a, 6b, 7a, 7b, the hydraulic bearing 1 according to the invention comprises a cage element that will be explained in detail below and that is embedded at least in sections in the elastomer body so that the elastomer body connects the cage element and the inner element 2 with one another. It can be provided, for example, that the inner element 2 and the cage element are elastically connected with one another by means of a multitude of elastomer portions like, for example, the described support spring portions 31a, 31b and chamber wall portions for the delimitation of respective fluid chambers 6a, 6b, 7a, 7b by a galvanizing process via the described elastomer portions.

In the representation of FIG. 1, two axially superimposed fluid chambers 6a, 6b that are separated in the horizontal direction by a transverse web 44 are identified, wherein the transverse web 44 that extends substantially perpendicularly to a bearing axis A of the inner element 2 is configured spaced from the inner element 2. This being, two axially contrary and bent inner elastomer chamber wall portions 33a, 33b extend from the radial end portion of the transverse web 44 to the outer circumferential surface of the inner element and adherent thereto so that a hollow space is formed between the two specified chamber wall portions 33a, 33b and an outer circumferential surface of the inner element 2. Both inner chamber wall portions 33a, 33b are arranged adherent to said radial end portion of the transverse web 44 of the cage element. In the axial direction, the fluid chambers 6a, 6b that may be seen in FIG. 1 and that are axially superimposed and arranged over the same circumferential portion of the bearing are closed by chamber wall portions 35a, 35b acting as swelling membrane portions that again are arranged adherent on the inner element 2 and on the cage element and that insofar extend radially between them.

In the described embodiment, a further pair of axially spaced fluid chambers 7a, 7b, not shown in the figure, can be configured diametrically opposite to the two fluid chambers 6a, 6b, wherein they can be configured and/or arranged in the same manner as the described fluid chambers 6a, 6b. Insofar, the two hydraulic bearing or fluid chamber pairs 6a, 6b and 7a, 7b do not extend over the whole circumference around the center, i.e. the inner element 2 of the hydraulic bearing 1 according to the invention, but over a predefined circumferential portion and are respectively separated in the circumferential direction by means of a support spring portion 31a, 31b of the hydraulic bearing 1.

The hydraulic bearing 1 according to the invention can comprise an annular plate 9 on an axial front side, wherein this annular plate has a stepped configuration and provides bearing surfaces for associated end faces of the inner element 2 and of the cage element or of the elastomer body.

The hydraulic bearing 1 according to the invention that is represented in FIG. 1 is configured for performing damping tasks in two “radial/axial” main working directions oriented perpendicularly to one another, wherein the response behavior of the hydraulic bearing 1 can be adjusted highly dependent thereon. The damping behavior is defined on the one hand by the arrangement of the elastomer portions of the elastomer body and on the other hand by the arrangement of the specified fluid chambers 6a, 6b, 7a, 7b fluidly connected by fluid channels. A first main working direction relates to a relative displacement of the inner element 2 and of the cage element in direction of the bearing axis A of the hydraulic bearing 1, a second main working direction relates to a relative radial displacement of the inner element 2 relative to the cage element, wherein the response behavior in the radial direction can again vary quite heavily in the section planes indicated in FIG. 1 that are oriented perpendicularly to one another. While the hydraulic bearing 1 has a high radial stiffness in case of a radial stress that acts within the section plane shown in FIG. 1 that comprises the support spring portion 31a and the diametrically opposite support spring portion 31b that is not shown in the figure, the hydraulic bearing 1 of Fig. shows, in case of a radial deflection, i.e. a displacement of the inner element 2 to the cage element in the section plane shown in FIG. 1 that comprises the transverse web 44 with the chamber wall portions 33a, 33b terminally extending in direction of the inner element 2, a low radial stiffness that is substantially defined by the specified elastomer chamber walls 35a, 35b and 33a, 33b as well as the damping behavior of the fluidly connected pairs of elastomer fluid chambers 6a, 6b and 7a, 7b. The functional principle of the multidirectional hydraulic damping bearing 1 according to the invention shall be addressed below after the basic structure of the hydraulic bearing 1 has been explained by referring to single components.

FIG. 2 shows a perspective view of the inner element 2 for designing the hydraulic bearing 1 according to the invention. In the described embodiment, the hydraulic bearing 1 comprises an inner core portion 21 and an outer portion 22, wherein the latter substantially provides the outer boundary surface, at least over the major part of the axial extension of the inner element 2. This being, the core portion 21 can be made of a metallic material, for example aluminum or steel, and the outer portion 22 of an injected part 26 to the core portion 21, for example comprising a plastic material that is materially connected to the core portion 21.

As may be seen in FIG. 2, the inner element 2 can comprise in an axial portion an approximately rectangular boundary surface with respectively two opposite side faces 24a, 24b and 25a, 25b that are arranged approximately parallel to one another. In the described embodiment, the two boundary surfaces 24a, 24b can be associated over the circumference to a respective pair of fluid chambers 6a, 6b and 7a, 7b, or substantially define them in their extension perpendicularly to the bearing axis A. Similarly, the opposite side faces 25a, 25b can be associated to or define a respective extension perpendicularly to the bearing axis A of the hydraulic bearing 1 of the support spring portions 31, 31b. The side faces 24a, 24b substantially flat or slightly bent and associated to the fluid chambers 6a, 6b, 7a, 7b can comprise flange collars 26a, 26b, extending radially outwards at least at one or, as in the described embodiment, at both longitudinal ends, that serve for the hydraulic bearing 1 according to the invention, in a manner that shall still be described, as axial pump surfaces and/or as coupling portions for the chamber walls 35a, 35b that close the respective fluid chamber 6a, 6b, 7a, 7b. In a modified embodiment, the flange collars 26a, 26b can also be configured circumferentially closed and/or annular around the core portion 21 of the inner element 2.

FIG. 3 shows a perspective view of an example of the structure of the cage element of the multidirectional hydraulic damping bearing 1 according to the invention. In this embodiment, the cage element 5 comprises two axially spaced ring portions 40a, 40b that are connected with one another by means of two radially or diametrically opposite longitudinal webs 42a, 42b. The longitudinal webs 42a, 42b have bent thickenings 421a, 421b extending radially inwards to the axial center to which the support spring portions 31a, 31b explained with reference to FIG. 1 can be arranged adherent thereto, wherein they in turn can adhere radially inwards to the inner element 2 so that the inner element 2 and the cage element 4 are elastically connected with one another in the final hydraulic bearing 1.

In the described embodiment, diametrically opposite transverse webs 44, 45 can be configured and arranged integrally with both radial thickenings 421a, 421b of the longitudinal webs 42a, 42b and connect them with one another. The coupling of the transverse webs 44, 45 to the respective radial thickenings 421a, 421b can be realized with associated fork arms 442a, 442b and 452a, 452b that start from an axial end face of the respective transverse web 44, 45 and bifurcate to an associated longitudinal web 42a, 42b by constituting a respective fork opening 443, 453. As a comparison of FIGS. 1 and 3 shows, the transverse webs 44, 45 form respective dividing wall portions to the respective pair of axially spaced fluid chambers 6a, 6b and 7a, 7b. In the described embodiment, the fork arms 442, 442b and 452a, 452b can serve as articulation surfaces for the elastomer chamber wall portions 33a, 33b and 34a, 34b that extend between the longitudinal webs 42a, 42b over the longitudinal extension of the transverse webs 44, 45, see further FIG. 1.

While the transverse webs 44, 45 have an approximately straight extension between the longitudinal webs 42a, 42b on their front face facing the inner element at which the elastomer chamber walls 33a, 33b and 34a, 34b engage by being axially spaced and axially contrary, the transverse webs 44, 45 comprise, at their front face facing the inner element 2 a respective radial projection 441, 4514 that penetrates, in a manner yet to be described, radially into a respective channel shell 80a, 80b for the described separation of the two axially superimposed fluid chamber pairs 6a, 6b and 7a, 7b and separated by the transverse webs 44, 45.

In the described embodiment, the channel shell 8 that is designed for the radial delimitation of the fluid chambers 6a, 6b and 7a, 7b to the outer sleeve 5 and for providing fluid channels between the fluid chambers 6a, 6b and 7a, 7b and thus for providing a fluid exchange between the fluid chambers 6a, 6b, 7a, 7b can be designed in two parts in the described embodiment.

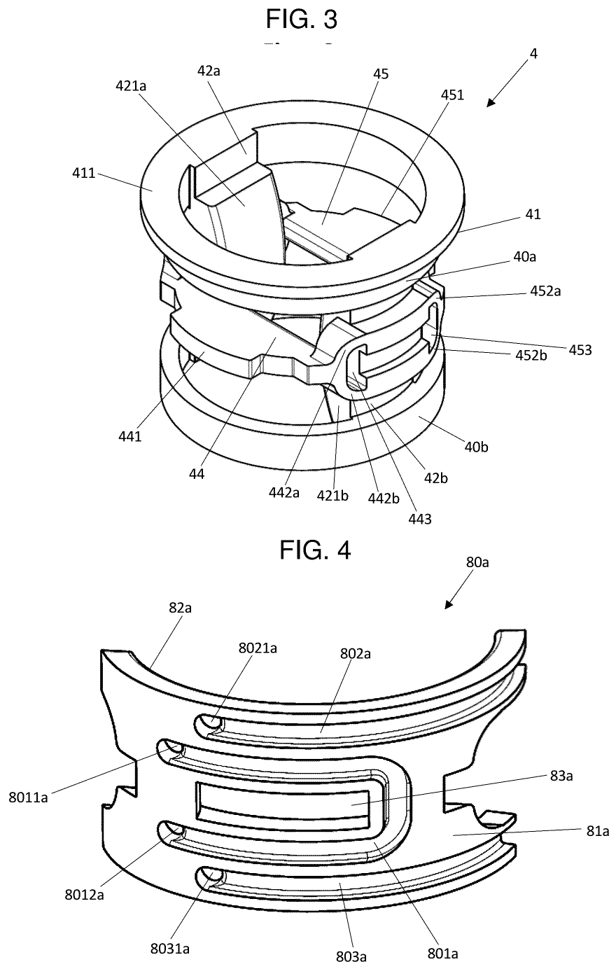

FIG. 4 shows such a channel half shell 80a in a perspective view with regard to the outer face 81a oriented in mounted condition to the outer sleeve 5, wherein the not represented channel half shell 82b can be designed accordingly. The channel half shell 80a shown in FIG. 4 has a passage 83a for receiving an associated radial projection 441 of the transverse web 44, see FIG. 3, approximately axially centrally over a predefined circumferential portion that can be, for example, between 30° and 10°. Insofar, this passage 83a marks this passage 83a the separation of the two axially superimposed fluid chambers 76a, 6b.

In the described embodiment, each of the channel half shells 80a, 80b that is here associated respectively to one pair of axially superimposed fluid chambers 6a, 6b ou 7a, 7b and that limits it radially can comprise two channel or radial passages 8011, 8021 or 8012 and 8031 for each of the fluid chambers 6a, 6b and 7a, 7b that merge into associated channel grooves 801, 802 and 803. These channel grooves 801a, 802a, 803a provide associated fluid channels to associated portions of the inner circumferential surface of the outer sleeve 5, fluid channels over which an exchange of fluid between the fluid chambers 6a, 6b and 7a, 7b can take place.

While for example the channel groove 801a with the associated radial passages 8011a and 8012a fluidly connects two fluid chambers 6a, 6b arranged superimposed and circumferentially over a same portion or overlapping, in mounted condition of the channel half shells, a fluid communication of two diametrically opposite fluid chambers 6a and 7a takes place via the in FIG. 4 upper channel groove 802a and a channel groove 802 oriented thereto of the second channel half shell 82b. The same applies correspondingly for two lower fluid chambers 6b, 7b with reference to FIG. 4 via the channel groove 803a and an associated channel groove 803b oriented thereto for the fluid communication of two fluid chambers 6b and 7b arranged in mounted condition approximately at the same axial height and diametrically opposite in the radial direction. As will be recognized by those skilled in the art, in the represented embodiment, each fluid chamber is fluidly connected with a fluid chamber over the same circumferential portion and axially spaced and furthermore fluidly connected with a fluid chamber axially at approximately the same height and radially diametrically opposite.

The channel shell 80 can, depending on the embodiment, be designed as an injection molded part, in particular as a two-part injection molded part, wherein embodiments made of a fiber reinforced plastic are also within the scope of the invention.

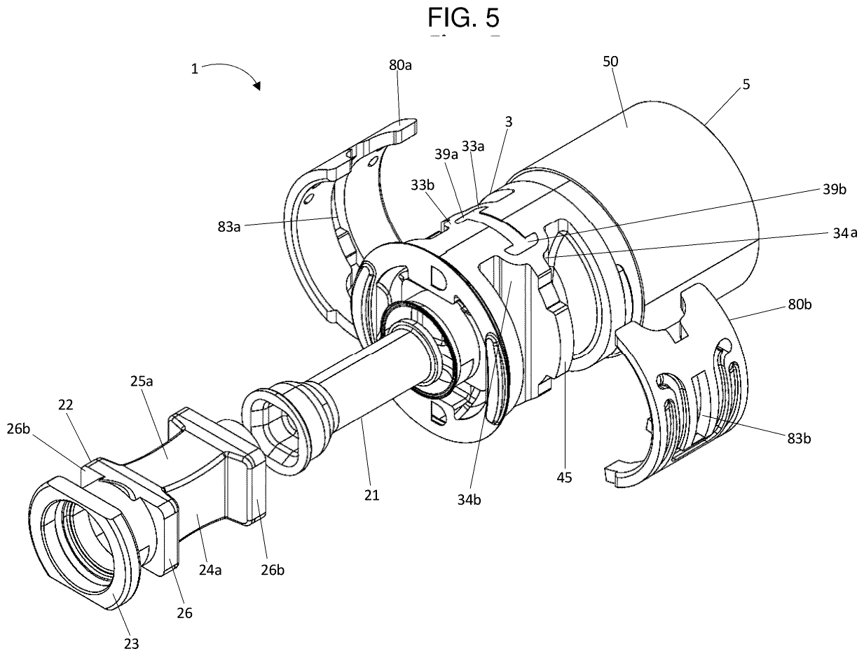

FIG. 5 shows a partial exploded view of the multidirectional hydraulic damping bearing 1 according to the invention for which the two-part inner element 2 in the described embodiment, the outer sleeve 5, the two half shells 80a, 80b as well as the elastomer body are represented with the cage element 4 embedded at least partially in the elastomer material axially or radially spaced from each other. It can be seen that the two channel half shells close radially respectively one pair of superimposed fluid chambers 6a, 6b and 7a, 7b that are axially separated by the transverse webs 44, 45 of the cage element 4. These fork-shaped chamber walls 33a, 33b and 34a, 34b extending radially and axially opposite constitute respective hollow spaces 39a, 39b that cannot appropriately be filled with damping fluid, in particular with damping liquid. It can appropriately be provided to fill these two hollow spaces 39a, 39b with a gas such as air and to close them in order to enable a high degree of mobility of the chamber walls 33a, 33b and 34a, 34b in case of operating stresses in the radial direction, in particular for adjusting a low radial stiffness of the multidirectional hydraulic damping bearing 1 according to the invention.

As may be seen in FIG. 5, the inner element can comprise a core portion 21 and an outer portion in form of an injected portion 26, wherein the latter can define the radial boundary surfaces of the inner element 2 in the region of the fluid chambers 6a, 6b and 7a, 7b.

As explained, it can be provided in an embodiment that the multidirectional hydraulic damping bearing 1 according to the invention comprises at least four fluid chambers 6a, 6b and 7a, 7b, wherein a pair of fluid chambers 6a, 6b and 7a, 7b is respectively axially superimposed over the same circumferential portion of the hydraulic bearing 1 or at least over an overlapping circumferential portion of the hydraulic bearing and a circumferentially spaced of fluid chambers, in particular a pair of fluid chambers radially diametrically opposite to the first fluid chamber pair, is provided to this pair of fluid chambers 6a and 6b or 7a and 7b. This being, the second pair of fluid chambers can again be circumferentially overlapping and axially superimposed over the same circumferential portion.

It can be provided that the two fluid chambers 6a and 6b or 7a and 7b of a respective pair of fluid chambers are fluidly connected by a single fluid channel and each fluid chamber of this fluid chamber pair with respectively another fluid chamber 6a, 6b, 7a, 7b of the other fluid chamber pair with approximately the same axial position so that in this embodiment each of the fluid chambers 6a, 6b, 7a, 7b in case of a radial relative displacement of the cage element 4 and of the inner element as well as in case of an axial relative displacement of the cage element 4 and of the inner element is part of a hydraulic system in which damping tasks can be performed. This being, it can be provided to adapt the respective channel parameters such as channel length and channel diameter to the desired damping so that the hydraulic damping behavior of the hydraulic bearing 1 according to the invention can be adjusted in the radial working direction and in the axial working direction independently from one another.

In another embodiment, it can also be provided to connect the described four fluid chambers 6a, 6b, 7a, 7b that comprise respectively a pair of axially superimposed fluid chambers only with two fluid channels, in particular in the art that a single fluid chamber of the first pair of fluid chambers 6a and 6b is connected with a single fluid chamber of the second fluid chamber pair 7a and 7b, wherein the fluidly connected fluid chambers are arranged circumferentially offset to one another, in particular diametrically opposite and additionally axially offset to one another. In this embodiment, each of the at least four fluid chambers also constitutes a part of a hydraulic system that acts in case of an axial stress of the hydraulic bearing 1 as well as in case of a radial stress of the bearing 1. Contrary to the embodiment with four fluid channels, here the hydraulic damping characteristics that are substantially defined by the design of the fluid channel that connects the respective two fluid chambers are set equal.

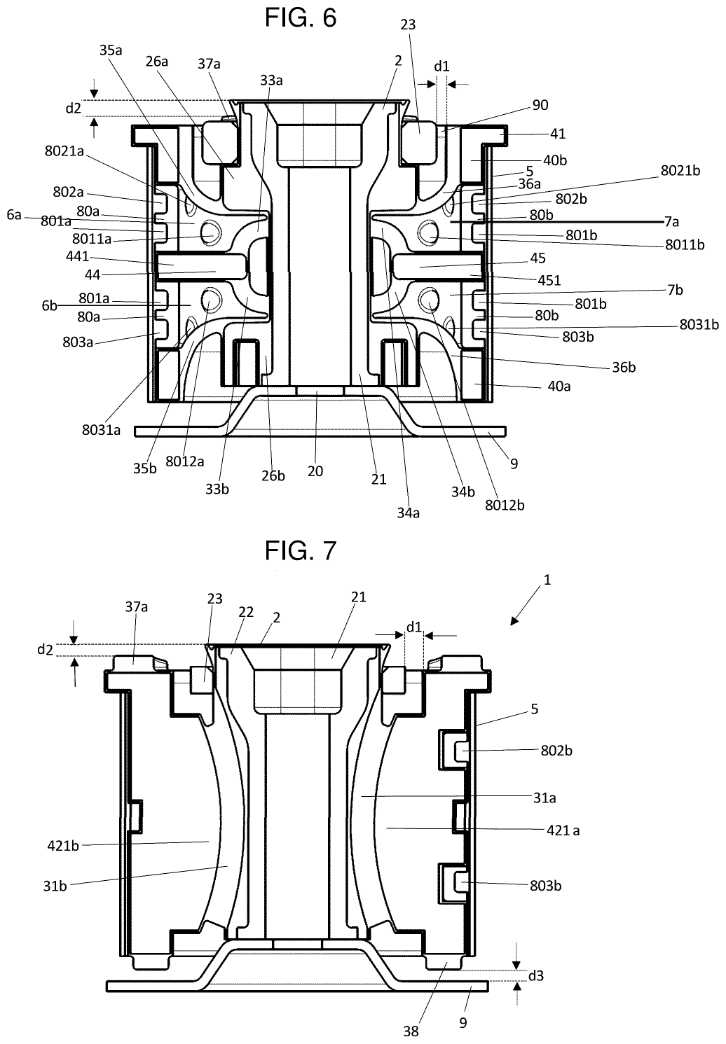

FIG. 6 shows a full section in the longitudinal direction of the hydraulic bearing 1 of FIG. 1 with regard to the here diametrically opposite fluid chamber pairs 6a, 6b and 7a, 7b that are both respectively separated by a transverse web 44, 45 and by chamber walls 33a, 33b, 34a, 34b engaging on the respective transverse web and extending to the inner element 2. Moreover, the two channel half shells 80a, 80b with their channel grooves 801a, 802a and 803a as well as their related channel passages 8011a, 8011b, 8012a, 8012b, 8021a, 8021b and 8031a, 8031b can be recognized. The fluid chambers 6a, 6b of the in FIG. 6 left fluid chamber pair are axially limited outwards by elastomer chamber walls 35a, 35b, the fluid chambers 7a, 7b of the in FIG. 6 right fluid chamber pair by the outer chamber walls 36a, 36b.

The hydraulic bearing 1 designed according to the invention and described with reference to the figures has design features for limiting the radial and the axial relative displacement of the inner element 2 and of the cage element 4 and the outer sleeve 5. For limiting the radial relative displacement, an annular abutment element 23 is arranged on a radial boundary surface in an axial end portion of the inner element 2, wherein in another embodiment this abutment element can be designed for example integrally with an injected part 26 to the core portion 21 of the inner element 2. A radial outer surface of the abutment element 23 is radially spaced by a distance d1 from a radial inner surface of the cage element 4 that is coated with elastomer. In the embodiment shown in the figures, the elastomer coating of the radial surface associated to the abutment element or to the abutment ring 23 can be designed as an axial extension of the outer chamber wall 35a, 36a within the circumferential portions of the fluid chamber pairs 6a, 6b and 7a, 7b.

A limitation of the relative axial displacement of the inner element and of the cage element 4 or of the outer sleeve 5 can be realized for the hydraulic bearing 1 according to the invention in that the inner element 2 is fixed to an upper portion in the orientation represented in FIG. 6 to a component that extends radially outwards into the region of the front area of the cage element 4, wherein elastomer abutments 37a, 37b are arranged at the front side thereof, see FIG. 1. As indicated in FIG. 6, the axial spacing of the mounted hydraulic bearing 1 according to the invention is thus limited to the distance d2.

FIG. 7 shows a full section of the hydraulic bearing 1 of FIG. 1 with regard to the radially or diametrically opposite support spring portions 31a, 31b that adhere, in the described embodiment, to the associated radial thickenings 421a, 421b of the longitudinal webs 42a, 42b of the cage element 4 and to outer surface portions of the inner element 2 and that are materially connected therewith. Furthermore, a further axial abutment, constituted by an inner axial surface of the annular plate 9 and an elastomer abutment 38a, 38b arranged in the figure on a lower front side of the cage element 4 for limiting an axial displacement of the inner element 2 and of the outer sleeve 5 to the distance d3 can be seen in the sectional representation of FIG. 7.

### LIST OF REFERENCE NUMERALS

1 Hydraulic bearing
2 Inner element
3 Elastomer body
4 Cage element
5 Outer sleeve
6a, 6b Fluid chamber, first pair of fluid chambers
7a, 7b Fluid chamber, second pair of fluid chambers
8 Channel shell
9 Annular plate
20 Bore
21 Core portion
22 Outer portion
23 Abutment element
24a, 24b Side face
25a, 25b Side face
26 Injected part
26a, 26b Flange collar
31a, 31b Support spring portion
33a, 33b Chamber wall
34a, 34b Chamber wall
35a, 35b Outer chamber wall
36a, 36b Outer chamber wall
37a, 37b Elastomer abutment
38a, 38b Elastomer abutment
39a, 39b Hollow space
40a, 40b Ring portion
41 Flange
42a, 42b Longitudinal web
44 Transverse web
45 Transverse web
50 Outer circumferential surface
51 Inner circumferential surface
80a, 80b Channel half shell
81a, 81b Outer surface
82a, 82b Inner surface
83a, 83b Passage
90 Radial distance
411 Front side of the flange
421a, 421b Radial thickening
441 Radial projection
442a, 442b Fork arm
443 Fork opening
451 Radial projection
452a, 452b Fork arm
453 Fork opening
801a, 801b Channel groove
802a, 802b Channel groove
803a, 803b Channel groove
805a, 805b Radial mount
8011a Radial passage
8011b Radial passage
8012a Radial passage
8012b Radial passage
8021a Radial passage
8021b Radial passage
8031a Radial passage
8031b Radial passage
A Axis
d1 Radial distance
d2 Radial distance
d3 Radial distance

What is claimed is:

1. A hydraulic damping bearing comprising:
an axially extending inner element;
an elastomer body;
a cage element that is embedded at least in sections in the elastomer body, wherein the elastomer body elastically connects the cage element and the inner element with one another;
an outer sleeve that wraps around the inner element, the cage element and the elastomer body;
at least a first and a second fluid chamber arranged respectively between the outer sleeve and the inner element that are connected by a fluid channel;
wherein further at least a third and a fourth fluid chamber are included that are arranged respectively between the outer sleeve and the inner element, and the at least four fluid chambers are fluidly connected via at least one further fluid channel, wherein each of the at least four fluid chambers is involved, in case of a relative displacement of the inner element and of the cage element in a first direction and of a relative displacement of the inner element and of the cage element in a second direction, in performing damping tasks.

2. The hydraulic damping bearing according to claim 1, wherein the bearing comprises at least two pairs of axially superimposed fluid chambers, wherein the at least two pairs are circumferentially spaced from each other, in particular are arranged radially opposite at the same axial height.

3. The hydraulic damping bearing according to claim 1, wherein the two fluid chambers of a respective pair of axially superimposed fluid chambers substantially extend over the same circumferential portion.

4. The hydraulic damping bearing according to claim 1, wherein the at least four fluid chambers have a substantially identical extension in the circumferential direction of the bearing.

5. The hydraulic damping bearing according to claim 1, wherein each of the at least four fluid chambers is fluidly connected by means of an associated fluid channel to a fluid chamber arranged radially opposite and in particular at the same axial height and to a fluid chamber arranged axially adjacent to the respective fluid chamber and in particular on the same circumferential portion by means of an associated fluid channel.

6. The hydraulic damping bearing according to claim 1, wherein respectively two fluid channels are arranged between the at least four fluid chambers for performing damping tasks in the axial direction and two fluid channels are arranged for performing damping tasks in the radial direction.

7. The hydraulic damping bearing according to claim 1, wherein each of the at least four fluid chambers is fluidly connected with a single one of the other three fluid chambers via a fluid channel, wherein the fluid chambers connected with one another are arranged radially opposite and axially consecutive.

8. The hydraulic damping bearing according to claim 1, wherein the cage element comprises in the longitudinal section of the bearing a first transverse web that extends radially in direction of the inner element for providing a respective axial pump surface for two fluid chambers of the at least four fluid chambers arranged over a predefined circumferential section and axially consecutive.

9. The hydraulic damping bearing according to claim 8, wherein the cage element comprises in the longitudinal section of the bearing a second transverse web, circumferentially spaced from the first transverse web, that extends radially in direction of the inner element for providing a respective axial pump surface for the two other fluid chambers arranged over a predefined circumferential section and axially consecutive.

10. The hydraulic damping bearing according to claim 8, wherein two inner elastomer chamber wall portions that are contrary and bent, adherent to the radial end portion of the respective transverse web that is facing the inner element, extend adherent to the inner element for the axial delimitation of the two axially consecutive fluid chambers.

11. The hydraulic damping bearing according to claim 8, wherein the cage element comprises at least two axially spaced ring portions that are connected by at least two in particular diametrically opposite longitudinal webs, wherein the first and/or the second transverse web is connected to the two longitudinal webs.

12. The hydraulic damping bearing according to claim 1, wherein at least two hollow spaces are comprised, extending in a transverse direction of the bearing to a longitudinal direction of the inner element, in particular linearly and parallel to one another and limited by elastomer wall portions, wherein they are respectively adjacent to the inner element.

13. The hydraulic damping bearing according to claim 1, wherein a two-part channel shell is provided that is arranged axially between the ring portions of the cage element and that terminates the fluid chambers to the outer sleeve and comprises radial recesses for providing at least two, in particular at least four fluid channels with associated inner wall portions of the outer sleeve.

14. The hydraulic damping bearing according to claim 1, wherein the inner element comprises an approximately square cross-section in the axial portion of the fluid chambers.

15. The hydraulic damping bearing according to claim 1, wherein the inner element comprises an in particular collar-like flange for providing an attachment on the inner part side of a respective outer chamber membrane wall.

16. The hydraulic damping bearing according to claim 1, wherein an annular abutment element is provided on an axial end portion of the bearing axially outside the fluid chambers on the inner element, this element being arranged radially spaced in the load-free state of the bearing from an elastomer portion arranged on an inner face of a ring element of the cage element.

17. The hydraulic damping bearing according to claim 1, wherein an axial front face of the cage is coated with an elastomer buffer that is situated axially below a front side end face of the inner element.

18. The hydraulic damping bearing according to claim 1, wherein the cage element is designed in two parts, wherein the two parts can be assembled in a longitudinal section plane in the transverse direction with radially acting complementary latching means that provide after latching an axial form-fit of the two cage elements.
